(19) United States
(12) Patent Application Publication
(10) Pub. No.: US 2005/0033998 A1
(43) Pub. Date: Feb. 10, 2005

(54) Power supply circuit and semiconductor integrated circuit device

(76) Inventors: Yoshimitsu Honda, Toyohashi-city (JP); Yoshinori Teshima, Toyota-city (JP); Hideaki Ishihara, Okazaki-city (JP); Toshihiko Matsuoka, Nukata-gun (JP); Katsutoyo Misawa, Nukaga-gun (JP)

Correspondence Address: POSZ & BETHARDS, PLC, 11250 ROGER BACON DRIVE, SUITE 10, RESTON, VA, 20190, US

(21) Appl. No.: 10/911,743

(22) Filed: Aug. 5, 2004

(30) Foreign Application Priority Data
Aug. 6, 2003 (JP) 2003-287617
Jan. 26, 2004 (JP) 2004-17366

(51) Int. Cl. G06F 1/30

(52) U.S. Cl. 713/300

(57) ABSTRACT

In a power supply circuit, when switches are turned off, current flows from a battery power supply line through resistors, input terminals, diodes and a terminal and further from a terminal into IC. When a microcomputer operates in a low power consumption operating mode, the power supply voltage is higher than a target voltage, and a control voltage output from an operational amplifier increases, so that a transistor is turned off. At this time, a current sink circuit operates and a transistor is turned on, so that excessive current flows into the current sink circuit to suppress increase of the power supply voltage.

### CROSS REFERENCE TO RELATED APPLICATIONS

This application is based upon, claims the benefit of priority of, and incorporates by reference the contents of, Japanese Patent Application No. 2003-287617 filed on Aug. 6, 2003 and Japanese Patent Application No. 2004-17366 filed on Jan. 26, 2004.

### FIELD OF THE INVENTION

The present invention relates to a power supply circuit for generating and outputting a voltage equal to a target voltage, and a semiconductor integrated circuit device using the power supply circuit.

### BACKGROUND OF THE INVENTION

JP-A-2001-5542 discloses a power supply circuit which is constructed by combining a control circuit internally equipped in an integrated circuit (IC) with a voltage dropping transistor externally equipped to the IC. JP-A-5-211527 discloses a DC terminal circuit for connecting a current sink circuit acting as low impedance and a low power consumption load to a voltage input terminal in accordance with a DC input voltage. JP-A-5-144271 discloses a semiconductor device for preventing gate oxide film of a first-stage gate of an input circuit for normal operation from being broken when a high voltage input is applied to an external terminal to which the input circuit and a high voltage detecting circuit are commonly connected. JP-A-2002-43924 discloses an input interface circuit of a semiconductor integrating circuit device used when a high voltage equal to a power supply voltage or more may be applied to an input terminal.

FIG. 13 shows a power supply circuit and protection circuits at an input port which are used in an electronic control unit (hereinafter referred to as ECU) of a vehicle. A controller of the power supply circuit 1, the input port and the input protection circuits 2, 3 are constructed as a part of IC 4 for control. IC 4 has a microcomputer 5, and a power supply voltage Vcc generated by the power supply circuit 1 is supplied to the microcomputer 5.

In order to prevent a battery from running out when a vehicle is left non-driven, the microcomputer 5 is designed to operate in a low power consumption operating mode as well as a normal operation mode. Development of recent IC technologies can further reduce current consumption in IC 4 when IC 4 is operating in a low power consumption operating mode. However, there occurs a new problem which has not hitherto occurred in conventional ICs having relatively large consumption current in the low power consumption operating mode. This problem will be described hereunder in detail.

In FIG. 13, the power supply circuit 1 comprises a series regulator which is supplied with a batter voltage VB (12V) as an input voltage to generate a power supply voltage Vcc (5V) from the input voltage VB. An operational amplifier 6 comprises an error amplifier for controlling the power supply voltage Vcc generated at the terminal 7 of IC 4 so that the power supply voltage Vcc thus generated is coincident with a target voltage (5V). Furthermore, the input protection circuits 2 and 3 connected to input terminals 8 and 9 respectively are constructed by diodes D1, D2 and diodes D3, D4 respectively. The diodes D1, D2 (the diodes D3, D4) are connected to each between terminals 10, 11. The terminal 10 is connected to the terminal 7 at the outside of IC 4.

An external signal in a voltage range from 0V to 5V is originally input to these input terminals 8 and 9, however, a voltage of more than 5V can be directly applied to the input terminals 8 and 9 by positively using the input protection circuits 2 and 3. For example, as shown in FIG. 13, in a case where a resistor R1 and a switch S1 are connected to each other in series between a battery power supply line 12 and a ground line 13 and also a common connection point therebetween is connected to the input terminal 8, the voltage of the input terminal 8 is set to 0V when the switch S1 is turned on. On the other hand, when the switch S1 is turned off, current flows through the resistor R1, the input terminal 8, the diode D1, the terminal 10 and the terminal 7, and thus the voltage of the input terminal 8 is set to about 5.6V. The same operation is carried out at the input terminal 9 to which a resistor R2 and a switch S2 are connected.

Current flowing to the terminal 7 (flow-in current) when the switches S1, S2 are turned off is determined by the battery voltage VB, the power supply voltage Vcc and the resistance values of the resistors R1, R2. When the microcomputer 5 is set to the low power consumption operating mode and thus the current consumed in IC 4 is smaller than the flow-in current described above, a current passage through which the flow-in current concerned is inpoured (sunk) vanishes in IC 4. Therefore, the operational amplifier 6 is kept uncontrollable, and thus the power supply voltage Vcc increases. Such a phenomenon is more critical as the consumption current of IC 4 in the low power consumption operating mode is reduced or as the number of input terminals directly-connected to the battery voltage VB for use is increased.

Therefore, a resistor R3 serving as a pseudo load is generally added to the terminal 7 in order to maintain a current inpouring (sinking) passage. Alternatively, a zener diode D5 is added to the terminal 7 in order to suppress an increase of the power supply voltage Vcc. However, in order to surely suppress the increase of the power supply voltage Vcc, it is required to use a resistor R3 having a resistance value sufficient to consume current flowing from the input protection circuits 2, 3 to the terminal 7 in consideration of the number of input ports (the number of input protection circuits), variation of the battery voltage VB, variation of the power supply voltage Vcc, the resistance values of the resistors R1, R2, variation of the resistor values with temperature variation, dispersion in the manufacturing process, etc.

Consequently, there has been hitherto such a problem that a sufficient low current consumption effect cannot be achieved in spite of reduction of current consumption of the microcomputer 5. Furthermore, when the resistor R3 or the zener diode D5 is externally equipped to IC 4, the area of a substrate is increased and the manufacturing cost is increased.

### SUMMARY OF THE INVENTION

The present invention has been implemented in view of the foregoing situation, and has an object to provide a power supply circuit for achieving a stable power supply voltage with reduced current consumption even when current flows into a power supply output terminal, and a semiconductor integrating circuit device.

According to a first aspect of the present invention, when current flowing to an output line (hereinafter referred to as “flow-in current”) is smaller than the total current of supply current to a load, operating current of a voltage generating circuit, operating current of a current sink circuit and consumption current thereof (that is, circuit consumption current), the flow-in current flows as the whole circuit consumption current, so that the voltage generating circuit generates an output voltage equal to a target voltage without operating the current sink circuit.

On the other hand, when the current flowing to the output line (i.e., the flow-in current) exceeds the circuit consumption current, excess current (overflow current) corresponding to the differential current between the flow-in current and the circuit consumption current is inpoured (sunk) into the current sink circuit to thereby prevent an increase of the output voltage. That is, the power supply circuit is designed so that the excess current is inpoured into the current sink circuit thereof. Therefore, as compared with the conventional construction in which a pseudo load resistor is connected to the output line at all times, there is no power consumption when no excess current occurs, and a voltage equal to a target voltage can be output while reducing the current consumption.

According to a second aspect of the present invention, when the output voltage increases beyond the target voltage because the current flowing into the output line (i.e., the flow-in current) exceeds the circuit consumption current, the current sink circuit carries out “inpouring (sink) operation” of excess current in connection with the increase of the output voltage. According to this construction, occurrence of excess current can be surely detected by using a unit for comparing the target voltage and the output voltage (specifically, a first error amplifier which will be described later or the like) which is originally equipped to the voltage generating circuit.

According to a third aspect of the present invention, the power supply circuit has a first feedback loop owned by the voltage generating circuit, and a second feedback loop owned by the current sink circuit. When the current flowing in the output line is smaller than the circuit consumption current, the voltage generating circuit outputs the voltage equal to the target voltage under the control of a first error amplifier. At this time, in the second feedback loop, a control voltage output from the first error amplifier is lower than a detection voltage of a voltage detecting circuit, and thus a second error amplifier controls a first transistor forming a current inpouring passage so that the first transistor is set to OFF-state.

On the other hand, when the current flowing in the output line exceeds the circuit consumption current, the control voltage output from the first error amplifier of the voltage generating circuit increases so that the output voltage is reduced. At this time, in the second feedback loop, the second error amplifier turns on the first transistor forming the current inpouring passage so that the control voltage output from the first error amplifier is coincident with the detection voltage of the voltage detecting circuit.

Accordingly, only the excess current can be made to inpour into the first transistor and thus the increase of the output voltage can be suppressed. Furthermore, since the increase of the output voltage which is caused when the current flowing in the output line exceeds the circuit consumption current is detected on the basis of the increase of the control voltage output from the first error amplifier, occurrence of the excess current can be surely detected even when dispersion occurs in circuit constant or the like.

According to a fourth aspect of the present invention, the power supply circuit is equipped with a first feedback loop associated with the voltage generating circuit and a second feedback loop associated with the current sink circuit, and the operation of the power supply circuit of the fourth aspect is the same as the power supply circuit of the third aspect. The second error amplifier equipped to the current sink circuit controls the first transistor in accordance with the differential voltage between the control voltage output from the first error amplifier and a constant reference voltage output from a reference voltage output circuit, so that no variation occurs in the reference voltage used in the second feedback loop and thus the inpouring (sink) operation of the excess current can be performed with higher precision.

According to a fifth aspect of the present invention, the power supply circuit is equipped with a first feedback loop owned by the voltage generating circuit and a second feedback loop owned by the current sink circuit. Second and third transistors are interposed in the first and second feedback loops respectively so as to be operated with the control voltage output from the first error amplifier as a gate voltage.

When the current flowing in the output line is smaller than the circuit consumption current, the second transistor is set to ON-state under the control of the first error amplifier, and the voltage generating circuit outputs the voltage equal to the target voltage. At this time, in the second feedback loop, the third transistor having a threshold voltage higher than the second transistor by a predetermined offset voltage is turned off, and the second error amplifier turns off the first transistor forming the current inpouring passage.

On the other hand, when the current flowing in the output line exceeds the circuit consumption current, the control voltage output from the first error amplifier of the voltage generating circuit increases so as to reduce the output voltage. As a result, in the second feedback loop, the third transistor is turned on, and the second error amplifier turns on the first transistor forming the current inpouring passage so that the drain voltage of the third transistor is coincident with a predetermined reference voltage, whereby only the excess current can be made to flow (inpour) into the first transistor and thus an increase in the output voltage can be suppressed.

When the present invention is applied to a semiconductor integrating circuit device (IC), an offset voltage (the difference between the threshold voltage of the second transistor and the threshold voltage of the third transistor) can be set with high precision, whereby a fluctuation range (the range corresponding to a dead zone on the control) of the control voltage output from the first error amplifier when the second feedback loop is shifted from a non-operation state to an operation state can be reduced.

That is, when the current flowing to the output line is smaller than the circuit consumption current, the third transistor can be surely set to OFF-state. When the current flowing to the output line exceeds the circuit consumption current, the third transistor is set to ON-state immediately when the control voltage output from the first error amplifier is slightly increased by the amount corresponding to the offset voltage, and thus the current sink operation is started. As a result, transitional variation of the output voltage which is caused by existence of the dead zone can be surely suppressed.

According to a sixth aspect of the present invention, when a voltage is applied to the input terminal, a start-up circuit maintains the first transistor in an OFF-state during the period from the application of the voltage to the input terminal until the output voltage reaches a predetermined voltage. Accordingly, at a transitional time just after the input voltage is applied, the first transistor forming the current inpouring passage is prevented from being turned on, so that the power supply circuit can be prevented from falling into a state where the output voltage does not rise up.

According to a seventh aspect of the present invention, when tracking control becomes impossible while the output voltage is kept to be higher than the target voltage because the current flowing to the output line exceeds the circuit consumption current, the current sink circuit makes the excess current flowing to the output line inpour into the current sink circuit itself so that the output voltage does not exceed a predetermined voltage set to be higher than the target voltage. Accordingly, a stable power supply voltage is achieved with reducing the current consumption.

According to an eighth aspect of the present invention, when an input signal voltage exceeding the power supply voltage is applied to a signal input terminal of a semiconductor integrating circuit device, the input protection circuit functions so that current flows from the signal input terminal through the input protection circuit to the power supply voltage line. Particularly when the microcomputer operates in the low power consumption operating mode, there easily occurs a case in which the flow-in current from the signal input terminal exceeds the consumption current of the semiconductor integrating circuit device. Even in this case, the excess current corresponding to the difference between the flow-in current and the consumption current can be sunken because the power supply circuit is equipped with the current sink circuit described above, and thus increase of the power supply voltage can be prevented while suppressing undesired power consumption. Accordingly, the semiconductor integrating circuit device can operate under the stable power supply voltage even when the microcomputer operates in any operating mode.

According to a ninth aspect of the present invention, current is made to flow into a pseudo load circuit during a predetermined return period just before the microcomputer is shifted form the low power consumption operating mode to the normal operating mode. This current is equal to or higher than the current flowing in the current sink circuit before the return control period, so that the sink operation of the current sink circuit is stopped and the voltage generating circuit restarts its function to generate the output voltage equal to the target voltage by the constant voltage action thereof.

The current flowing in the pseudo load circuit is smaller than the consumption current of the microcomputer in the normal operating mode. Therefore, as compared with the shift time of the microcomputer from the low power consumption operating mode to the normal operating mode, reduction of the output voltage which occurs at the passage time of the dead-zone where neither the current sink circuit nor the voltage generating circuit functions at the start time of the return control period is smaller. Since the microcomputer is shifted from the low power consumption operating mode to the normal operating mode under the state that the voltage generating circuit takes a constant voltage action at the time when the return control period has passed, there is no dead zone on control at the shift time, and the reduction of the output voltage can be prevented.

According to a tenth aspect of the present invention, each of the current sink circuit and the pseudo load circuit is equipped with a series circuit comprising a resistor and a transistor which forms a current inpouring passage, and the respective series circuits have the same characteristic. The pseudo load control circuit detects the gate voltage of the transistor constituting the series circuit of the current sink circuit before the return control period, and applies a gate voltage higher than the gate voltage thus detected to the transistor constituting the series circuit constituting the pseudo load circuit during the return control period. Accordingly, current which is equal to or larger than the current flowing in the current sink circuit before the return control period can be made to flow into the pseudo load circuit, and the output voltage equal to the target voltage can be generated by the constant voltage action of the voltage generating circuit.

In this construction, the difference between the gate voltage detected for the transistor constituting the series circuit of the current sink circuit and the gate voltage applied to the transistor constituting the series circuit of the pseudo load circuit is set to a small value while keeping a dispersion-anticipated margin, whereby current near to the current flowing in the current sink circuit before the return control period can be made to flow in the pseudo load circuit, and thus the output voltage can be prevented from being reduced when shifting to the return control period.

According to an eleventh aspect of the present invention, when the low power consumption operating mode is selected, the microcomputer intermittently shifts to the normal operation mode and operates in the normal operation mode. Particularly, when current flows to the power supply terminal under the state that the microcomputer operates in the low power consumption operating mode, the power supply voltage may increase as described above. Therefore, when increase of the power supply voltage is detected under the state that the microcomputer operates in the low power consumption operating mode, the microcomputer continues to operate under the state that it is shifted to the normal operating mode, and consumes the flow-in current concerned as operating current thereof to thereby suppress the increase of the power supply voltage.

In this case, no problem occurs in the processing of the microcomputer even when the microcomputer continues to operate in the normal operating mode needing larger processing power than the low power consumption operating mode. Furthermore, as compared with the conventional construction in which the pseudo load resistor is added, there is no unnecessary power consumption when no excess current occurs, and the voltage equal to the target voltage can be stably output with reducing the current consumption.

According to a twelfth aspect of the present invention, a comparator compares the power supply voltage with a judgment reference voltage value which is set to be higher than a predetermined voltage value (for example, rated voltage value), and detects increase of the power supply voltage on the basis of the comparison result.

According to a thirteenth aspect of the present invention, the period of the intermittent operation is set to a predetermined value or less. Therefore, even when the current flow-in described above occurs during the intermittent operation while the microcomputer operates in the low power consumption operating mode, the power supply voltage does not exceed the maximum permissible voltage (for example, the maximum rated voltage) within a time until the present operating mode (low power consumption operating mode) is shifted to a next normal operating mode. When the power supply voltage detecting circuit is operated even in the low power consumption operating mode and the increase of the power supply voltage is detected, the operating mode is immediately shifted to the normal operating mode without waiting for the shift to the next normal operating mode.

According to a fourteenth aspect of the present invention, when the power supply voltage detecting circuit detects the increase of the power supply voltage during the period when the low power consumption operating mode is selected, the operating mode is immediately shifted to a voltage suppression operating mode having larger current consumption than the low power consumption operating mode without waiting for a scheduled next normal operating mode, and thus the increase range of the power supply voltage can be suppressed to a small range. The voltage suppression operating mode at this time may be the normal operating mode.

According to a fifteenth aspect of the present invention, the low power consumption operating mode or the voltage suppressing operating mode is selected in response to a signal output from a hysteresis comparator during a period when it is scheduled to select the low power consumption operating mode in the intermittent operation. Therefore, when current flows into the power supply terminal, the increase of the power supply voltage can be suppressed with reducing the current consumption at the maximum.

According to a sixteenth aspect of the present invention, when current flows into the power supply terminal, a pseudo load circuit into which substantially the same flow-in current flows can be constructed. That is, the microcomputer selects the voltage suppression operating mode because the current flowing into the power supply terminal exceeds the current flowing in the pseudo load circuit. Accordingly, the current flowing in the pseudo load circuit is stepwise or continuously increased every time the voltage suppression operating mode is selected, whereby the current flowing in the power supply terminal and the current flowing in the pseudo load circuit can be balanced to be substantially equal to each other. Even when current is made to flow in the pseudo load circuit as described above, the current consumption can be frequently reduced more greatly than the case where the microcomputer is shifted to the normal operating mode. When no shift to the voltage suppression operating mode occurs during a predetermined period, the current to flow into the pseudo load circuit may be controlled to be temporarily increased and then reduced.

According to a seventeenth aspect of the present invention, when an excess voltage exceeding the power supply voltage is input to the signal input terminal, the input signal voltage is clamped to the power supply voltage by the input protection circuit, and thus the semiconductor integrating circuit device can be protected from an excess input voltage.

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram showing the electrical construction of an IC and its peripheral circuit according to a first embodiment of the present invention;

FIG. 2 is a diagram showing the electrical construction of a start-up circuit;

FIG. 3 is a diagram showing a second embodiment of the present invention which corresponds to FIG. 1;

FIG. 4 is a diagram showing a third embodiment of the present invention which corresponds to FIG. 1;

FIG. 5 is a diagram showing a fourth embodiment of the present invention which corresponds to FIG. 1;

FIGS. 6A-6F are diagrams showing signal waveforms and voltage waveforms of respective parts;

FIG. 7 is a diagram showing a fifth embodiment of the present invention which corresponds to FIG. 1;

FIGS. 8A-8C are diagrams showing voltage waveforms and operating modes when a microcomputer mainly operates in a low power consumption operating mode;

FIG. 9 is a diagram showing a sixth embodiment of the present invention which corresponds to FIG. 1;

FIGS. 10A-10C are diagrams corresponding to FIGS. 8A-8C;

FIG. 11 is a diagram showing a seventh embodiment of the present invention which corresponds to FIG. 1;

FIGS. 12A-12C are diagrams corresponding to FIGS. 8A-8C; and

FIG. 13 is a diagram showing related art which corresponds to FIG. 1.

### DETAILED DESCRIPTION OF THE PREFERRED EMBODIMENTS

Preferred embodiments according to the present invention will be described hereunder with reference to the accompanying drawings.

(First Embodiment)

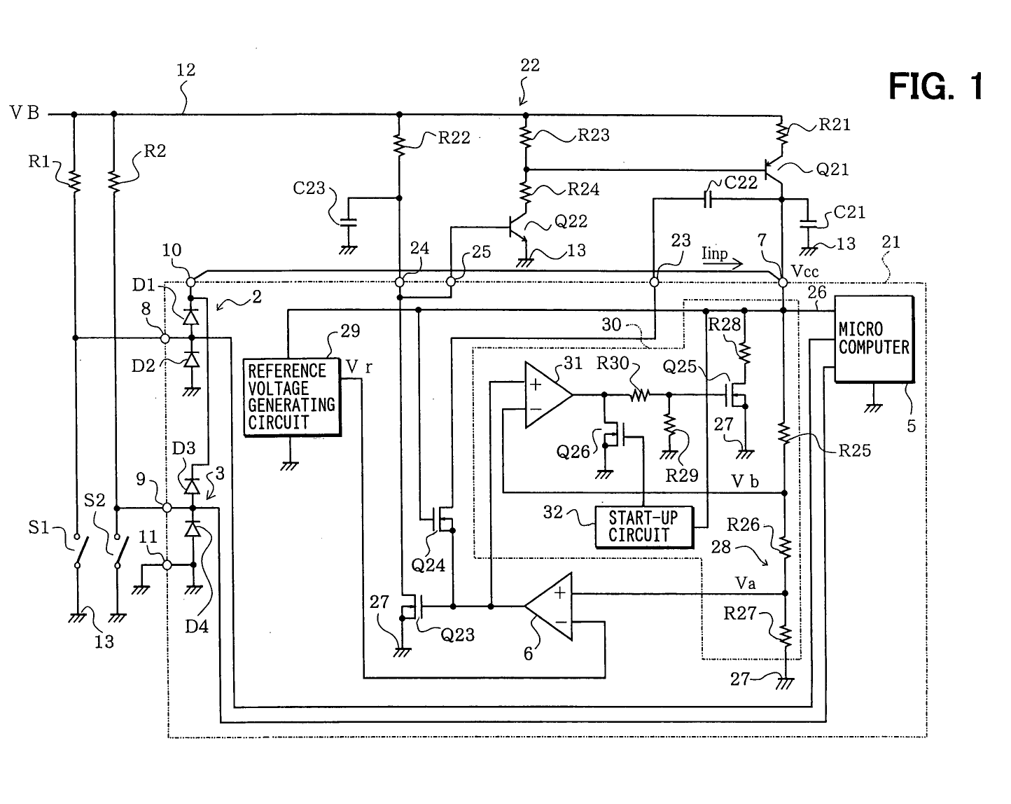

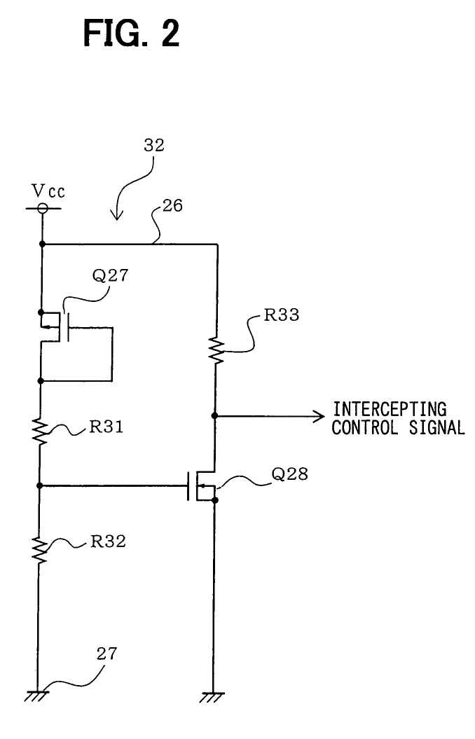

A first embodiment according to the present invention will be described with reference to FIGS. 1 and 2.

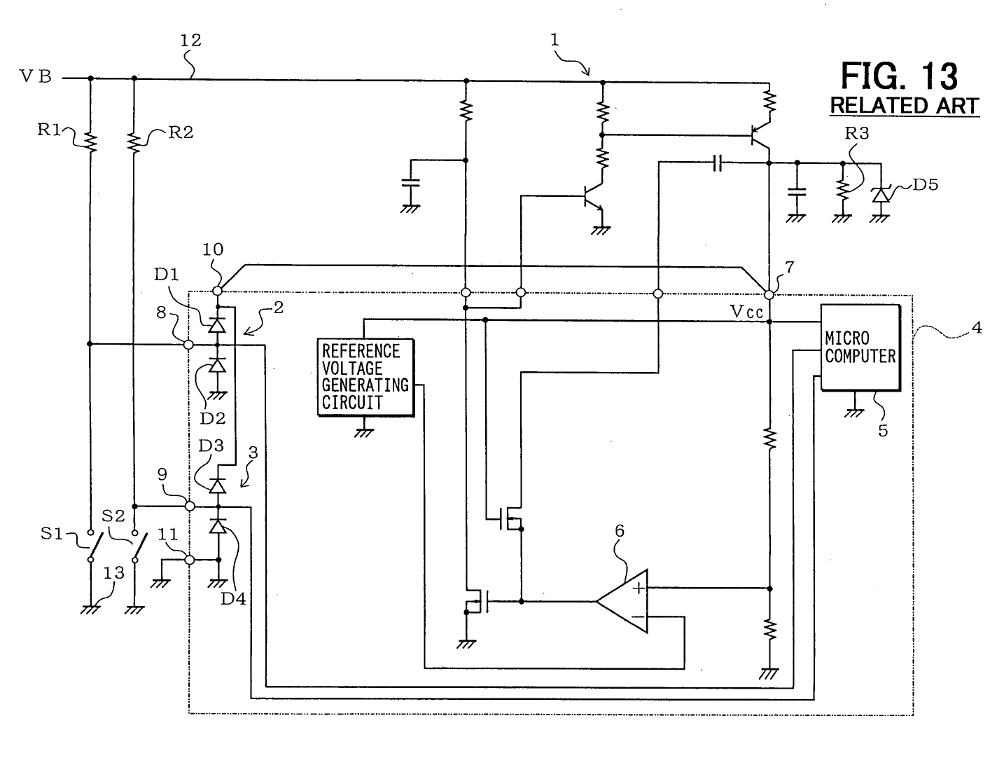

FIG. 1 is a diagram showing the construction of a power supply circuit used for an ECU (Electronic Control Unit) of a vehicle and an input protection circuit at an input port. In FIG. 1, the same constituent elements as those of FIG. 13 are represented by the same reference numerals.

IC 21 for control (corresponding to a semiconductor integrating circuit device) contains a microcomputer 5, input protection circuits 2, 3 for the input port of the microcomputer 5, and a control circuit of the power supply circuit 22, etc. IC 21 is mounted on a board (not shown) accommodated in the housing of ECU. As described above, the microcomputer (corresponding to a load) can operate in the low power consumption operating mode as well as the normal operating mode.

When a battery voltage VB is applied to each of signal input terminals 8, 9, each of the input protection circuits 2, 3 clamps the input voltage to the power supply voltage Vcc to protect IC 21 from an excess voltage. Furthermore, even when a negative voltage is applied between the battery power supply line 12 and the ground line 13, each input protection circuit 2, 3 clamps the input voltage to the ground potential to protect IC 21. Only two signal input terminals 8, 9 are shown in FIG. 1, however, a larger number of signal input terminals and input protection circuits in connection with the signal input terminals are actually equipped.

The power supply circuit 22 is a series regulator type constant-voltage power supply circuit, and it is supplied with the battery voltage VB (for example, 12V) so that a power supply voltage Vcc (for example, 5V) to be supplied to the microcomputer 5 and the other IC internal circuits is generated at the terminal 7. A resistor R21 and a PNP type transistor Q21 are connected to each other in series between the battery power supply line 12 (corresponding to an input line) and the terminal 7 of IC 21 at the outside of IC 21, and a smoothing capacitor C21 is connected between the terminal 7 and the ground line 13 while a phase compensating capacitor C22 is connected between the terminal 7 and the terminal 23 at the outside of IC 21.

The terminals 24 and 25 of IC 21 are connected to each other inside IC. A resistor R22 is connected between the terminal 24 and the battery power supply line 12, and a capacitor C23 is connected between the terminal 24 and the ground line 13. The resistors R23, R24 and the NPN type transistor Q22 are connected to one another between the battery power supply line 12 and the ground line 13, and the base of the transistor Q22 is connected to the terminal 25.

The constituent elements equipped to the inside of IC 21 in the circuit construction of the power supply circuit 22 are constructed as follows.

That is, a voltage dividing circuit 28 (corresponding to the voltage detecting circuit) comprising a series circuit of resistors R25, R26 and R27 is connected between the power supply line 26 (corresponding to the output line) connected to the terminal 7 and the ground line 27 connected to the terminal 11, and a common connection point between the resistors R26 and R27 is connected to the non-inverted input terminal of the operational amplifier 6 (corresponding to the first error amplifier). A reference voltage Vr is applied from a reference voltage generating circuit 29 such as a band gap reference voltage circuit or the like to the inverted input terminal of the operational amplifier 6.

The output terminal of the operational amplifier 6 is connected to the gate of an N-channel type MOS transistor Q23, and the drain and source of the transistor Q23 are connected to the terminals 24, 25 and the ground line 27, respectively. The output terminal of the operational amplifier 6 is also connected to the terminal 23 through the source and drain of the N-channel type MOS transistor Q24, and the gate of the transistor Q24 is connected to the power supply line 26. The transistor Q24 functions as a resistor, and constitutes a phase compensating circuit in combination with the capacitor C22. The forgoing construction is the construction of the voltage generating circuit in the power supply circuit 22.

Furthermore, a current sink circuit 30 is connected between the power supply line 26 and the ground line 27. The current sink circuit 30 inpours therein excess current of current flowing into the terminal 7 (power supply line 26) from the external to leak the excess current to the ground line 27, thereby suppressing increase of the power supply voltage Vcc. The voltage dividing circuit 28 also functions as a part of the current sink current 30. A resistor R 28 and an N-channel type MOS transistor Q25 (corresponding to a first transistor) are connected to each other in series between the power supply line 26 and the ground line 27. A resistor R29 is connected between the gate and source of the transistor Q25.

An operation amplifier 31 corresponds to a second error amplifier, and the non-inverted input terminal thereof is connected to the output terminal of the operational amplifier 6 while the inverted input terminal thereof is connected to a common connection point between the resistors R25 and R26. The output terminal of the operational amplifier 31 is connected to the gate of the transistor Q25 through a resistor R30, and further connected to the ground line 27 through the N-channel type MOS transistor Q26. The gate of the transistor Q26 is supplied with an interrupting control signal from a start-up circuit 32. The start-up circuit of this invention comprises the start-up circuit 32 described above and the transistor Q26.

FIG. 2 shows the construction of the start-up circuit 32. A series circuit comprising a P-channel type MOS transistor Q27 and resistors R31, R32 and a series circuit comprising a resistor R33 and an N-channel type MOS transistor Q28 are connected between the power supply line 26 and the ground line 27. The gate and drain of the transistor Q27 are connected to each other. The gate of the transistor Q28 is connected to a common connection point between the resistors R31 and R32. The interrupting control signal described above is output from the drain of the transistor Q28.

In the above construction, the operational amplifiers 6, 31 and the reference voltage generating circuit 29 operate while supplied with the power supply voltage Vcc. In this embodiment, the values of the resistors R25, R26, R27 and the reference voltage Vr are set so that a detection voltage Va applied to the operational amplifier 6 when the voltage supply voltage Vcc is equal to 5V (target voltage) is equal to 1.4V, and a detection voltage Vb applied to the operational amplifier 31 during a sink operation described later is equal to 1.75V.

Next, the operation of this embodiment will be described.

The input terminals 8, 9 are equipped with input protection circuits 2, 3 respectively. The input protection circuits 2 and 3 clamp the power supply voltage Vcc (5V) and 0V by using diodes D1, D2 and diodes D3, D4, respectively. Therefore, not only a signal having a voltage range from 0V to 5V, but also a signal having a voltage exceeding 5V or a voltage less than 0V can be input to the input terminals 8, 9. In this embodiment, one ends of the switches S1, S2 are pulled up to the battery supply line 12 by the resistors R1 and R2 respectively, and thus ON/OFF state of the switches S1 and S2 can be directly detected without separately adding a level shift circuit or the like.

This will be described in detail with respect to the input terminal 8. That is, when the switch S1 is turned on, the voltage of the input terminal 8 is equal to 0V, and thus it is input as an L-level signal to an input port of the microcomputer 5. On the other hand, when the switch S1 is turned off, the input terminal 8 is kept to be pulled up to the battery power supply line 12 by the resistor R1, and thus current Iinp1 (for example, about 100_{”} A) flows from the battery power supply line 12 through the resistor R1, the input terminal 8, the diode D1 and the terminal 10 and further flows through the terminal 7 to IC 21. At this time, the voltage of the input terminal 8 is restricted to Vcc+VF (≈5.6V, VF represents a forward voltage), and it is input as an H-level signal to the input port of the microcomputer 5. The same operation is satisfied for the input terminal 9. Furthermore, when both the switches S1 and S2 are turned off, current of Iinp (=Iinp1+Iinp2) flows from the terminal 7 to IC 21.

The operational amplifier 6 of the power supply circuit 22 amplifies the differential voltage between the reference voltage Vr corresponding to the target voltage (5V) and the detection voltage Va detected by the voltage dividing circuit 28, and outputs the differential voltage thus amplified as a control voltage to mainly control the base potential of the transistor Q21 through the transistors Q23 and Q22. For example when the power supply voltage Vcc is higher than the target voltage by 5V, the control voltage is increased, so that the base potential of the transistor Q22 decreases and the base potential of the transistor Q21 increases to reduce the power supply voltage Vcc. As described above, the operational amplifier 6 varies the ON-state (emitter-collector voltage) of the transistor Q21 on the basis of the voltage deviation to control the power supply voltage Vcc to 5V.

The total consumption current Icc (load current) of all circuits such as the microcomputer 5, the operational amplifiers 6, 31, the reference voltage generating circuit 29, the start-up circuit 32, etc. installed in IC 21 is equal to about several tens mA when the microcomputer 5 is in a normal operating mode, and it is reduced to, for example, about 100_{”} A when the microcomputer 5 is in a low power consumption operating mode. Accordingly, when the microcomputer 5 is in the normal operating mode, the overall flow-in current Iinp flows into the IC internal circuits such as the microcomputer 5, etc. as a part of the consumption current Icc, and thus the operational amplifier 6 can control the power supply voltage Vcc to 5V.

On the other hand, when the microcomputer 5 is in the low power consumption operating mode, excess current Iov (=Iinp−Icc) corresponding to the extra current of the current Iinp over the consumption current Icc cannot flow into the IC internal circuits such as the microcomputer 5, etc., and alternatively flows (inpours) into the current sink circuit 30. In this case, the power supply voltage Vcc at the terminal 7 increases beyond 5V. The operational amplifier 6 increases the control voltage to increase the emitter-collector voltage of the transistor Q21, and finally controls the transistor Q21 to the OFF-state completely. However, the power supply voltage Vcc cannot be restored to 5V under the control of only the operational amplifier 6 because the increase of the voltage is caused by the flow-in current Iinp.

In this case, the feedback control associated with the operational amplifier 31 of the current sink circuit 30 mainly acts in place of the feedback control associated with the operational amplifier 6 which falls into an uncontrollable state. That is, the operational amplifier 31 controls the ON-state of the transistor Q25 so that the control voltage of the operational amplifier 6 is equal to the detection voltage Vb.

This detection voltage Vb is set to a voltage higher than the control voltage output from the operational amplifier 6 under the state that the operational amplifier 6 is enabled to control the power supply voltage Vcc to 5v. Specifically, this detection voltage Vb is set to a voltage value which is equal to or more than the sum of a threshold voltage Vt of the transistor Q23 which is estimated as the highest value in consideration of dispersions such as temperature variation, battery voltage variation, etc., the maximum offset voltage of the operation amplifier 6 and an operating margin voltage and also at which the power supply voltage Vcc is restricted to the maximum rated voltage of IC 21 or less as a result of the control.

Accordingly, the operational amplifiers 6 and 31 are prevented from competing with each other in feedback control and thus both the transistors Q21 and Q25 are turned on. When the operational amplifier 31 carries out the above feedback control, excess current Iov flows into the transistor Q25 and thus increase of the power supply voltage Vcc of the terminal 7 can be surely restricted.

The operation of the power supply circuit 22 is uncertain during the period from the time when the battery voltage VB is applied till the time when the power supply voltage Vcc rises up some degree, and the transistor Q25 may be set to ON-state. When the operational amplifier 6 controls the transistor Q21 under such a condition, there occurs a case where both the transistors Q21 and Q25 are turned on and thus the power supply voltage Vcc does not rise up.

Therefore, the start-up circuit 32 directly applies the power supply voltage Vcc to the gate of the transistor Q26 until the power supply voltage Vcc rises up to 2·Vt, which corresponds to the sum of the threshold voltages Vt of the transistors Q27 and Q28 (see FIG. 2). Accordingly, the transistor Q26 is turned on, and the transistor Q25 can be kept to OFF-state. Here, the restriction of the time period corresponding to the rise-up of 2·Vt resides in that when the power supply voltage Vcc increases up to 2·Vt or more, the operational amplifier 31 can operate substantially normally.

As described above, IC 21 of this embodiment contains the microcomputer 5 operable in the low power consumption operating mode and the control circuit of the power supply circuit 22, and the power supply circuit 22 for the microcomputer 5 can be constructed by merely equipping some elements externally. Furthermore, the input protection circuits 2 and 3 for clamping the input voltage to the power supply voltage Vcc (5V) or 0V are equipped to the input terminals 8, 9 connected to the input port of the microcomputer 5, and a signal having a voltage exceeding 5V or a voltage less than 0V can be directly input to the input terminals 8 and 9.

Even when the flow-in current Iinp flowing to the terminal 7 exceeds the consumption current Icc of IC 21 because the microcomputer 5 operates in the low power consumption operating mode, the current sink circuit 30 of the power supply circuit 22 operates so that the excess current Iov flows (inpours) into the current sink circuit 30, so that the increase of the power supply voltage Vcc is restricted and the power supply voltage Vcc near to 5V can be stably supplied to the internal circuit of IC 21. The current sink circuit 30 has the excellent characteristic of merely inpouring the excess current Iov therein, unlike the pseudo load resistor (R3 of FIG. 13) used in the prior art, so that no unnecessary power consumption occurs.

The operational amplifier 31 of the current sink circuit 30 starts the current sink operation when the control voltage of the operational amplifier 6 increases beyond the control voltage in the normal control operation. Accordingly, both the transistors Q21 and Q25 can be surely prevented from being turned on. Furthermore, since the start-up circuit 32 is equipped, the power supply voltage Vcc can be surely made to rise up.

(Second Embodiment)

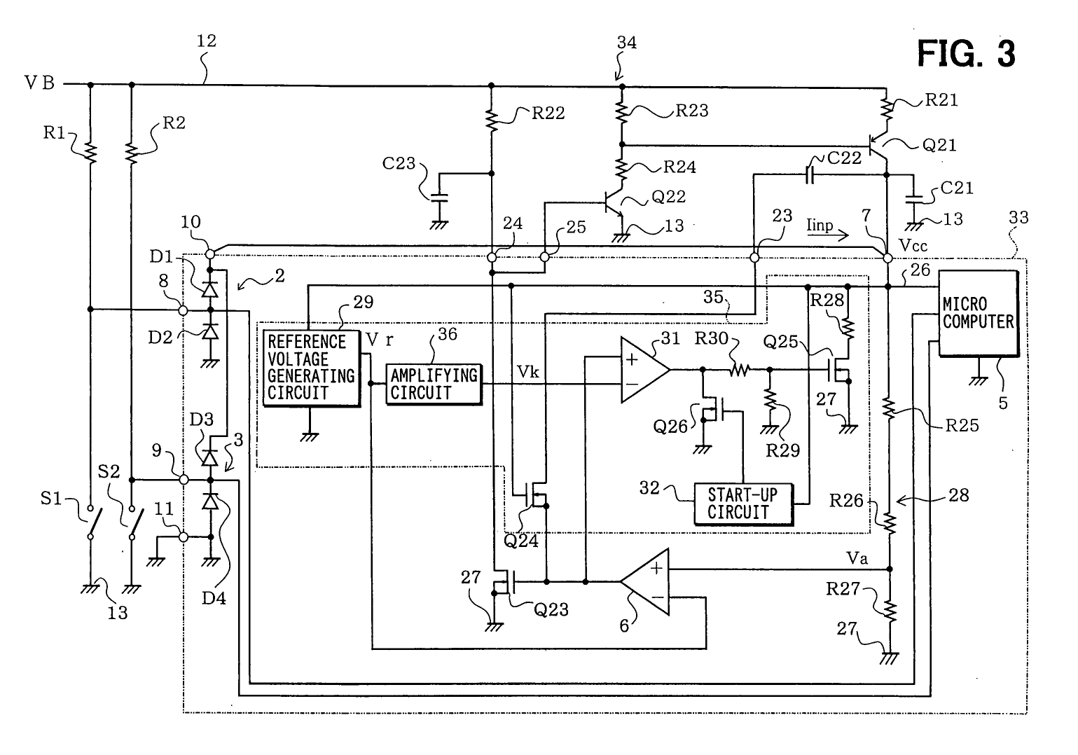

Next, a second embodiment of the present invention will be described with reference to FIG. 3.

FIG. 3 shows the construction of a power supply circuit and the constructions of input protection circuits for an input port, and the same constituent elements as FIG. 1 are represented by the same reference numerals. This embodiment is partially different from the first embodiment in a part of the construction of a current sink circuit 35 of a power supply circuit 34 installed in IC 33. That is, the current sink circuit 35 is equipped with a reference voltage generating circuit 29 and an amplifying circuit 36 in place of the voltage dividing circuit 28. The amplifying circuit 36 amplifies the reference voltage Vr input from the reference voltage generating circuit 29 to generate a constant reference voltage Vk (for example, 1.75V). Therefore, the reference voltage Vk thus generates is applied to the inverted input terminal of the operational amplifier 31.

The operation of the power supply circuit 34 is substantially the same as the operation of the power supply circuit 22, and the same effect as the first embodiment can be achieved. Furthermore, the invariable (fixed) reference voltage Vk is applied to the inverted input terminal of the operational amplifier 31, so that the current sink circuit 35 can perform the sink operation of the excessive current with higher precision when the current Iinp flowing into the terminal 7 exceeds the consumption current Icc of IC 21.

(Third Embodiment)

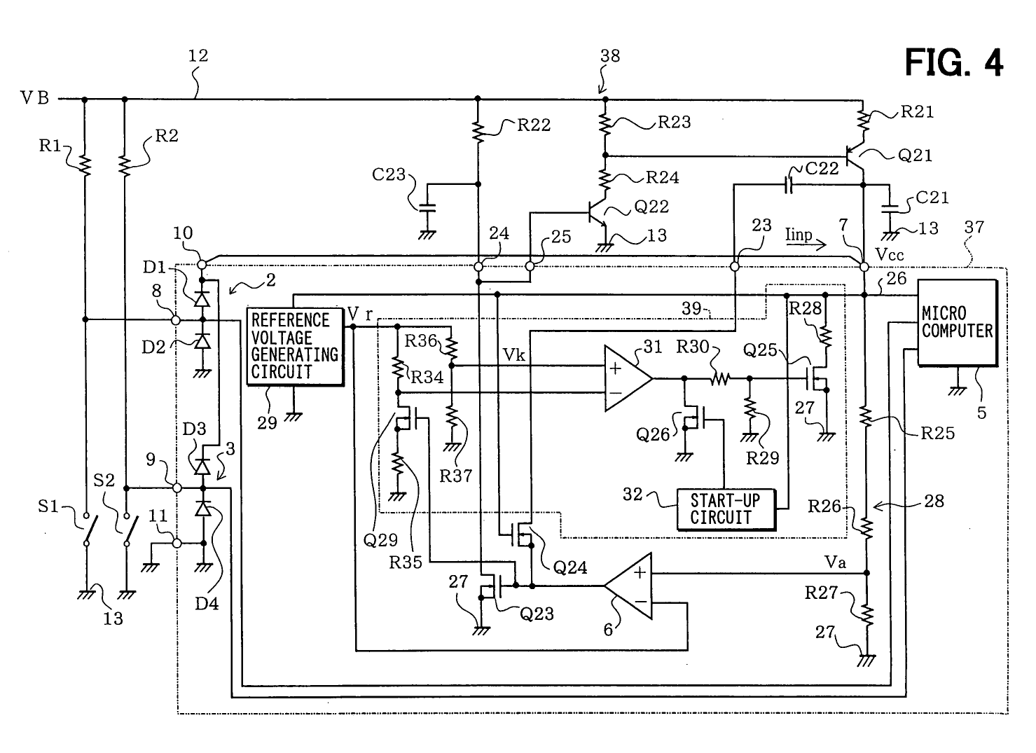

Next, a third embodiment according to the present invention will be described with reference to FIG. 4.

FIG. 4 shows the construction of a power supply circuit and input protection circuits for an input port, and the same constituent elements as FIG. 1 are represented by the same reference numerals. This embodiment is different from the first embodiment in a part of the construction of a current sink circuit 39 of the power supply circuit 38 installed in IC 37.

That is, a series circuit comprising a resistor R34, an N-channel type MOS transistor Q29 (corresponding to a third transistor) and a resistor R35 and a series circuit comprising resistors R36 and R37 are connected between the output terminal of the reference voltage generating circuit 29 and the ground line 27. A common connection point between the resistor R34 and the drain of the transistor Q29 and a common connection point between the resistors R36 and R37 are connected to the inverted input terminal and non-inverted input terminal of the operational amplifier 31, respectively. The gate of the transistor Q29 and the gate of the transistor Q23 (corresponding to a second transistor) are connected to the output terminal of the operational amplifier 6.

The transistors Q23 and Q29 are designed to have the same characteristic. With respect to the threshold voltages Vt of the transistors Q23 and Q29, some dispersion in threshold voltage may occur on the manufacturing of IC 37 between the transistors Q23 and Q29, however, the relative deviation therebetween is extremely small even in the above case. A resistor R35 between the source of the transistor Q29 and the ground line 27 is added so that the threshold voltage of the transistor Q29 with the ground potential as a standard voltage is higher than the threshold voltage of the transistor Q23 by only a predetermined offset voltage.

When the microcomputer 5 is set to the normal operating mode and the overall flow-in current Iinp flowing into the terminal 7 flows into the IC internal circuits such as the microcomputer 5, etc. as a part of the consumption current, the operational amplifier 6 amplifies the differential voltage between the reference voltage Vr and the detection voltage Va to output the control voltage, and the transistor Q23 is set to ON-state. In this case, the transistor Q29 whose threshold voltage (with the ground potential as a standard) is higher than that of the transistor Q23 by only the offset voltage is turned off, and the sink operation of the current sink circuit 39 is not carried out.

On the other hand, when the microcomputer 5 is set to the lower power consumption operating mode and thus the flow-in current Iinp into the terminal 7 exceeds the consumption current Icc, the power supply voltage Vcc at the terminal 7 increases beyond 5V. Accordingly, the operational amplifier 6 increases the control voltage and the transistor Q29 is changed to ON-state at the time point when the control voltage increases by only the offset voltage. The operational amplifier 31 controls the ON-state of the transistor Q25 so that the control voltage of the operational amplifier 6 is equal to the reference voltage Vk, so that excessive current Iov flows into the transistor Q25 and thus the increase of the power supply voltage Vcc at the terminal 7 can be restricted.

According to this embodiment, the same effect as the first embodiment can be achieved. Furthermore, the offset voltage of the transistor Q29 to the transistor Q23 can be set with high precision, and also the fluctuation range of the output voltage (control voltage) of the operational amplifier when the current sink current 39 is shifted from the non-operating state to the operating state can be reduced.

As a result, when the flow-in current Iinp flowing into the terminal 7 is smaller than the consumption current Icc, the transistor Q29 can be surely set to OFF-state, and it can be surely prevented that both the transistors Q21 and Q25 are turned to an ON-state. On the other hand, when the flow-in current Iinp flowing into the terminal 7 exceeds the consumption current Icc, the transistor Q29 is immediately set to an ON-state if the output voltage of the operational amplifier 6 is slightly increased by only the offset voltage, and the current sink operation is started. Accordingly, the dead zone corresponding to the period for which the current sink circuit 39 is shifted from the non-operation state to the operating state is narrowed, and transitional variation of the power supply voltage Vcc which is caused by the dead zone concerned can be surely suppressed.

(Fourth Embodiment)

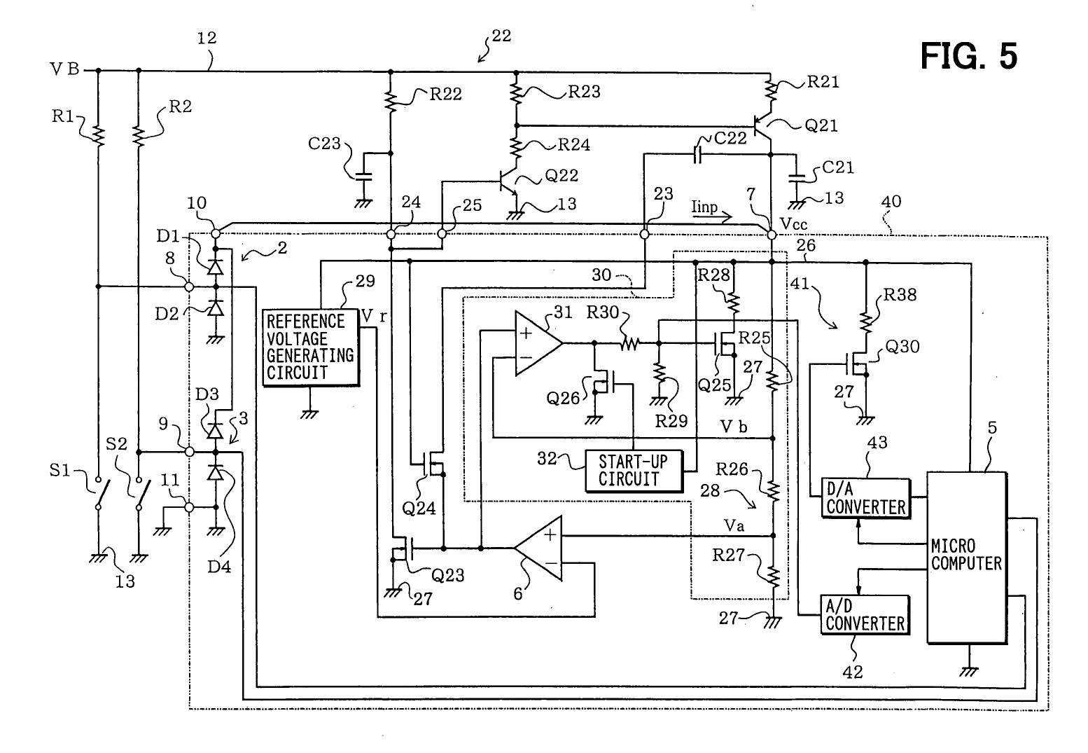

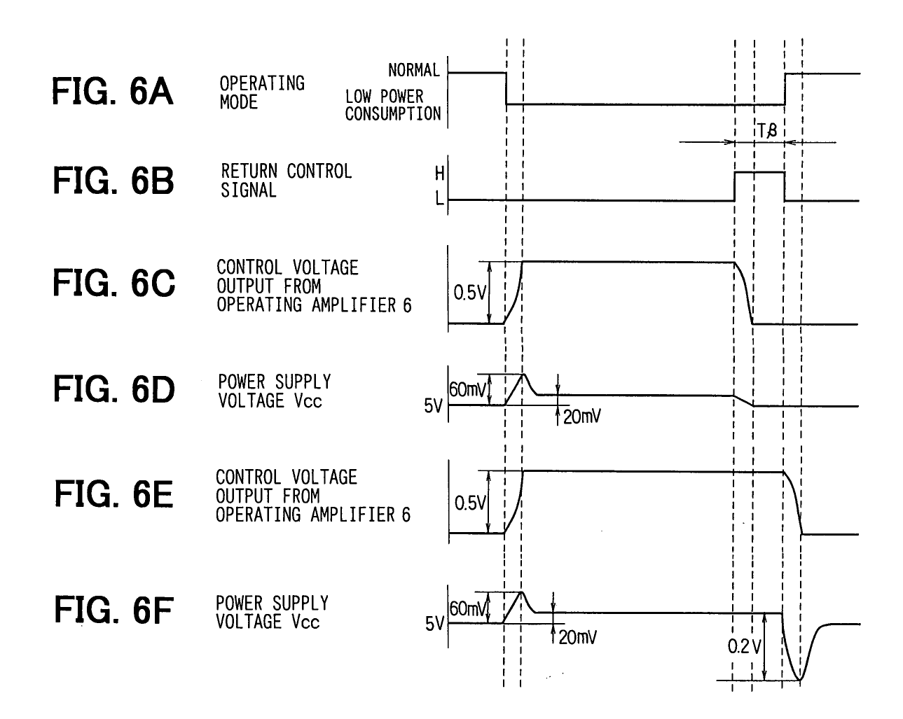

Next, a fourth embodiment according to the present invention will be described with reference to FIGS. 5 and 6A-6F.

FIG. 5 shows the constructions of a power supply circuit applied to IC and input protection circuits for IC, and the same constituent elements as FIG. 1 are represented by the same reference numerals. In IC 40, a pseudo load circuit 41 comprising a series circuit of a resistor R38 and an N-channel type MOS transistor Q30 equipped between the power supply line 26 and the ground line 27. The pseudo load circuit 41 is designed so as to have the same characteristic as the series circuit of the resistor R28 and the transistor Q25 in the current sink circuit 30, that is, it is designed so that the resistors R38 and R28 have the same resistance values and the transistors Q30 and Q25 have the same characteristic.

Furthermore, IC 40 is equipped with an A/D (analog-to-digital) converter 42 for subjecting the gate-source voltage of the transistor Q25 to A/D conversion to achieve digital data and then outputting the digital data to the microcomputer 5, and a D/A (digital-to-analog) converter 43 for subjecting the digital data output from the microcomputer 5 to D/A conversion and then applying the analog data thus achieved to the gate of the transistor Q30. The A/D converter 42 and the D/A converter 43 are controlled by the microcomputer (corresponding to the pseudo load control circuit), and they are designed so that power supply to each converter 42,43 can be individually interrupted to stop each converter. The corresponding relation between the analog voltage value and the digital value is set to be equal between the A/D converter 42 and the D/A converter 43.

Next, the operation of this embodiment will be described with reference to FIGS. 6A-6F, which show signal waveforms and voltage waveforms of respective parts. FIG. 6A represents the operating mode of the microcomputer 5. FIG. 6B represents a return control signal in the microcomputer 5. FIG. 6C represents a control voltage output from the operational amplifier 6. FIG. 6D represents a power supply voltage Vcc. Furthermore, FIGS. 6E and 6F represent waveforms corresponding to FIGS. 6C and 6D in the first embodiment. The voltage scales of FIGS. 6C-6F are not identical to one another because of some restriction to preparation of drawings, and thus voltage values are described as examples on the drawings.

First, an operation when no pseudo load circuit 41 is equipped (the first embodiment) will be described.

When the microcomputer 5 shifts from the low power consumption operating mode to the normal operating mode, the overall consumption current Icc of IC 40 increases stepwise, and when the capacitance of the capacitor C21 is small, the power supply voltage Vcc drops drastically. At this time, the operational amplifier 6 attempts to reduce the control voltage to be output therefrom. However, since the output terminal of the operational amplifier 6 is connected to the phase compensating capacitor C22 through the transistor Q24, the control voltage falls with some delay (FIG. 6E) while being dependent on the current sink capability of the N-channel type transistor (not shown) constituting the output stage of the operational amplifier 6, the capacitance of the capacitor C22, etc.

Consequently, the time period corresponding to the dead zone in which neither the feedback control based on the operational amplifier 6 nor the feedback control based on the operational amplifier 31 acts is longer, and there occurs a phenomenon that the power voltage Vcc temporarily decreases beyond 5V as shown in FIG. 6F. This phenomenon can be solved by increasing the capacitance of the capacitor C21, however, the capacitor C21 must be increased in size by the amount corresponding to the increase of the capacitance.

Therefore, the following control is carried out in this embodiment. That is, the A/D converter 42 and the D/A converter 43 which have been turned off are turned on by the microcomputer 5 before a predetermined time Tβ (this period corresponds to the return control period) prior to the shift from the low power consumption operating mode to the normal operating mode, and an A/D conversion value (digital value N) of the gate-source voltage of the transistor Q25 is input from the A/D converter 42 to the microcomputer 5. Subsequently, a value (N+α) achieved by adding the digital value N with α is subjected to D/A conversion by the D/A converter 43, and the D/A output voltage thus achieved is applied to the gate of the transistor Q30.

As a result, the transistor Q30 is turned on, and current larger than current which has flowed through the series circuit of the resistor 28 and the transistor Q25 in the current sink circuit 30 until that moment flows into the pseudo load circuit 41. Accordingly, the overall excess current Iov of the flow-in current Iinp from the terminal 7 over the consumption current Icc can be made to flow into the pseudo load circuit 41. Therefore, the power supply voltage Vcc drops and the operational amplifier decreases the control voltage. At this time, the feedback control associated with the operational amplifier 31 is stopped, and the constant voltage action is carried out by the feedback control associated with the operational amplifier 6 again.

The additive value α is used to surely make the current flowing in the pseudo load circuit 41 larger than the current flowing in the current sink circuit 30, and the additive value α is preferably set to be as small as possible insofar as the magnitude relation in current as described above is satisfied. If the additive value α is set to be excessively large, the current flowing in the pseudo load circuit 41 would be excessive, and the temporary reduction phenomenon of the power supply voltage Vcc as described above occurs at the start time of the return control period Tβ.

As described above, if the feedback control associated with the operational amplifier 6 is made to act normally before the microcomputer 5 shifts from the low power consumption operating mode to the normal operating mode, there would be no time period corresponding to the dead zone of the control because no switching operation of the feedback control is carried out even when the microcomputer 5 is shifted to the normal operating mode and thus the consumption current Icc increases drastically, so that the power supply voltage Vcc can be fixedly kept to 5V (FIG. 6D). When the microcomputer 5 shifts from the low power consumption operating mode to the normal operating mode, the microcomputer 5 turns off the power supply of the A/D converter 42 and the D/A converter 43, and in connection with this turn-off operation, the transistor Q30 is turned off.

According to this embodiment, the capacitance of the capacitor C21 can be more greatly reduced than the first embodiment, and this embodiment is more advantageous in the size of a board on which IC 40 is mounted, the manufacturing cost, etc. Furthermore, the capacitance required to the capacitor C21 can be substantially fixed irrespective of the system construction using the power supply circuit 22, and thus the degree of freedom of applying the power supply circuit 22 to the system can be enhanced.

Power is supplied to the A/D converter 42 and the D/A converter 43 for only the return control period Tβ, and the current flowing in the pseudo load circuit 41 for the return control period Tβ is substantially equal to or slightly larger than the current which has flowed in the current sink circuit 30 until that moment. In addition, the return control period Tβ may be only a time period required to complete the switching of the above control operation. Therefore, as compared with the first embodiment, increase of the power consumption hardly occurs.

(Fifth Embodiment)

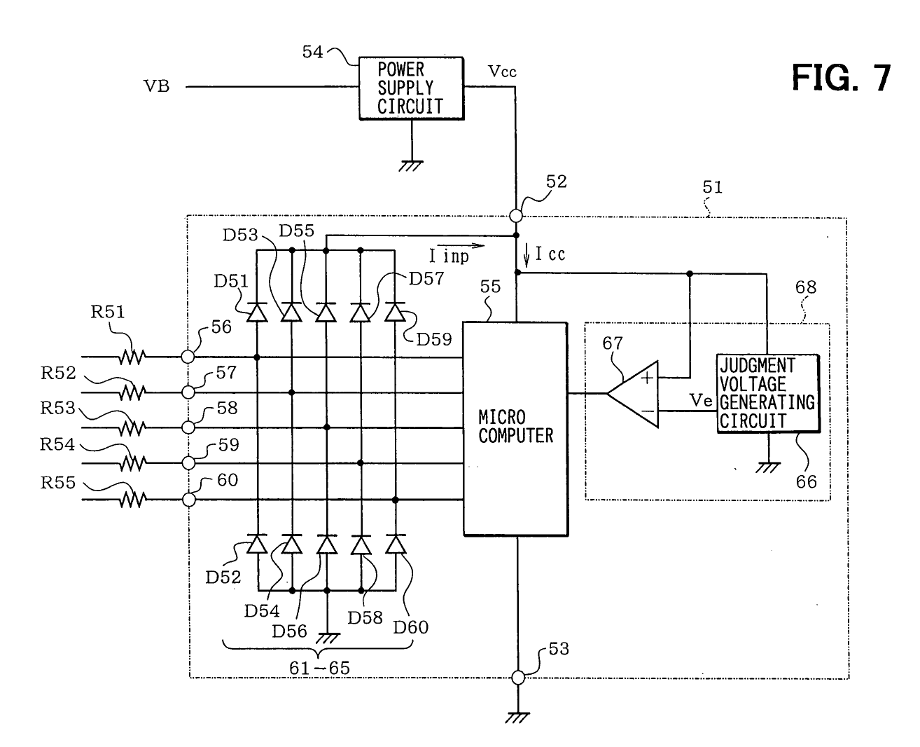

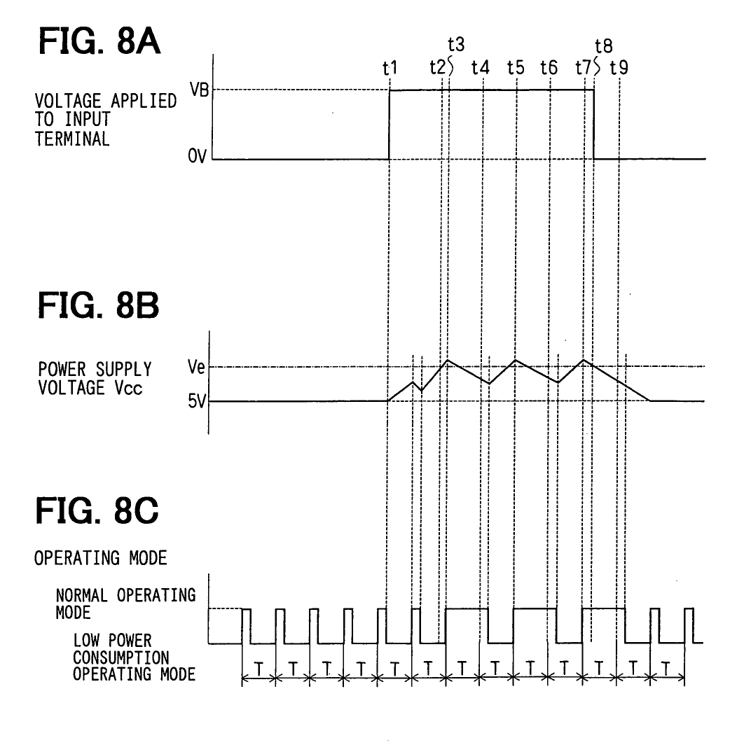

Next, a fifth embodiment of the present invention will be described with reference to FIGS. 7 and 8A-8C.

FIG. 7 shows the electrical construction of a control IC used for ECU of a vehicle. A power supply voltage Vcc is supplied from a power supply circuit 54 (corresponding to an external power supply circuit) at the outside of IC to power supply terminals 52 and 53 of IC 51 (semiconductor integrated circuit device). The power supply circuit 54 is a series regulator type constant-voltage power supply circuit, and it is supplied with a battery voltage VB of about 12V to output the power supply voltage Vcc of 5V.

IC 51 is equipped with a microcomputer 55. The microcomputer 55 has CPU, a memory, digital circuits such as input/output ports, etc., and various analog circuits. Input terminals 56 to 60 (corresponding to signal input terminals) of IC 51 are connected to input ports of the microcomputer 55 through input protection circuits 61 to 65. The input protection circuit 61 comprises a diode Dd51 connected between the input terminal 56 and the power supply terminal 52, and a diode D52 connected between the input terminal 56 and the power supply terminal 53. The other input protection circuits 62 to 65 are designed in the same structure.

The input terminals 56 to 60 are originally supplied with external signals in a voltage range from 0V to 5V. However, by positively using the input protection circuits 61 to 65, a voltage exceeding 5V can be directly applied to these input terminals 56 to 60. In this embodiment, it is assumed that a battery voltage VB is applied through the resistors R51 to R55.

IC 51 is further equipped with a power supply voltage detecting circuit 68 comprising a judgment voltage generating circuit 66 and a comparator 67. The judgment voltage generating circuit 66 (corresponding to a judgment reference voltage generating circuit) is a circuit for generating a fixed judgment voltage Ve (corresponding to a judgment reference voltage) higher than the power supply voltage Vcc. Furthermore, the comparator 67 compares the power supply voltage Vcc with the judgment voltage Ve, and outputs a judgment signal of L level when the power supply voltage Vcc is lower than the judgment voltage Ve while outputting a judgment signal of H level when the power supply voltage Vcc is equal to the judgment voltage Ve or more. This judgment signal is applied to an input port of the microcomputer 55.

Next, the operation of this embodiment will be described with reference to FIGS. 8A-8C.

As described above with respect to the first embodiment, when a voltage exceeding 5V is applied to the input terminals 56 to 60 (accurately, signal source side terminals of the resistors R51 to R55), current flows through the diodes D51 to D59. When this flow-in current Iinp exceeds the consumption current Icc of the IC internal circuits, the power supply voltage Vcc increases beyond 5V. Specifically, the voltage rises up when the microcomputer 55 is in the low power consumption operating mode and the battery voltage VB is applied to some of the input terminals 56 to 60.

FIGS. 8A-8C show the voltage waveforms when the microcomputer 55 mainly operates in the low power consumption operating mode and the operating mode. FIG. 8A shows the voltage waveform applied to the input terminals 56 to 60. FIG. 8B shows the power supply voltage Vcc. FIG. 8C shows the operating mode of microcomputer 55

In FIG. 8A, it is shown that the battery voltage VB is applied to the input terminals 56 to 60 at the same time to show a case where rise-up of the power supply voltage Vcc occurs. The battery voltage VB may be applied to some of the input terminals 56 to 60 insofar as the rise of the power supply voltage Vcc rises up.

The microcomputer 55 temporarily returns to the normal operating mode (or a mode in which only a part of the function thereof is normally operated) at a constant period T even after an ignition key of a vehicle is turned off and thus the microcomputer shifts to the low power consumption operating mode, and executes the monitoring processing of the input signal. At the return time, the microcomputer 55 receives a judgment signal from the comparator 67, and shifts to the low power consumption operating mode again when the judgment signal is L-level. The period T is generated by a CR timer, for example.

When the battery voltage VB is applied to the input terminals 56 to 60 (time t1), the flow-in current Iinp into the power supply terminal 52 exceeds the consumption current Icc of the IC internal circuits, so that the power supply voltage Vcc increases beyond 5V. The rate of increase at this time is settled on the basis of the excess current Iov (=Iinp−Icc), the capacitance value of the smoothing capacitor in the power supply circuit 54, etc. Finally, when the power supply voltage Vcc exceeds the judgment voltage Ve at a time t2, the judgment signal of the comparator 67 is inverted from L-level to H-level.

When the period T elapses from the previous return time point and the microcomputer 55 returns to the normal operating mode again (time t3), the microcomputer 55 prohibits the shift to the low power consumption operating mode in response to the fact that the judgment signal is H-level, and continues to operate in the normal operating mode until the period T elapses. In the normal operating mode, the consumption current Icc of the IC internal circuits is larger than the flow-in current Iinp, and thus the power supply circuit 54 can control the power supply voltage Vcc to 5V. As a result, the power supply voltage Vcc is reduced to 5V, and the judgment signal is inverted to L-level again. Since the judgment signal is L-level at a time t4 at which the period T has elapsed, the microcomputer 55 shifts to the low power consumption operating mode after the predetermined monitoring processing is finished.

Thereafter, the microcomputer 55 carries out the same operation according to the level of the judgment signal at times t5, t6, t7 at which the period T has elapsed. When the application of the battery voltage VB to the input terminals 56 to 60 is stopped (time t8), the current Iinp is equal to zero and the power supply voltage Vcc is finally regulated to 5V. The microcomputer 55 carried out the intermittent operation of the period T as a matter of principle after a time t9.

In this case, the microcomputer 55 judges the level of the judgment signal at the time when it shifts from the low power consumption operating mode to the normal operating mode because of the lapse of the period T, and thus if the period T is long, the power supply voltage Vcc may exceed the maximum rated voltage (corresponds to the maximum permissible voltage) of IC 51 until the microcomputer 55 returns to the next normal operating mode. Therefore, it is required that the period T is set to ΔVm/Rm[s] or less, wherein Rm [V/s] represents the maximum voltage increase rate estimated when the maximum value of the battery voltage VB is applied to all the input terminals 56 to 60 at the same time, and ΔVm [V] represents the voltage difference between the judgment voltage Ve and the maximum rated voltage. Accordingly, when the judgment signal is set to H-level during the operation in the low power consumption operating mode, the power supply voltage Vcc is prevented from exceeding the maximum rated voltage until the microcomputer returns to the next normal operating mode.

As described above, when the power supply voltage Vcc exceeds the judgment voltage Ve, IC 51 of this embodiment prohibits the shift from the normal operating mode to the low power consumption operating mode after it temporarily shifts to the normal operating mode. Accordingly, the consumption current Icc of the IC internal circuits is larger than the flow-in current Iinp and the increase of the power supply voltage Vcc is suppressed, so that the power supply voltage of 5V is stably supplied to IC 51. In this case, even when the microcomputer 55 continues to operated in the normal operating mode having a larger processing capability than the low power consumption operating mode, no problem occurs in the processing of the microcomputer 55. Furthermore, as compared with the conventional construction added with the pseudo load resistor, there is no unnecessary power consumption when no excess current Iov occurs, and the power supply voltage equal to the target voltage can be stably achieved with reducing the current consumption.

(Sixth Embodiment)

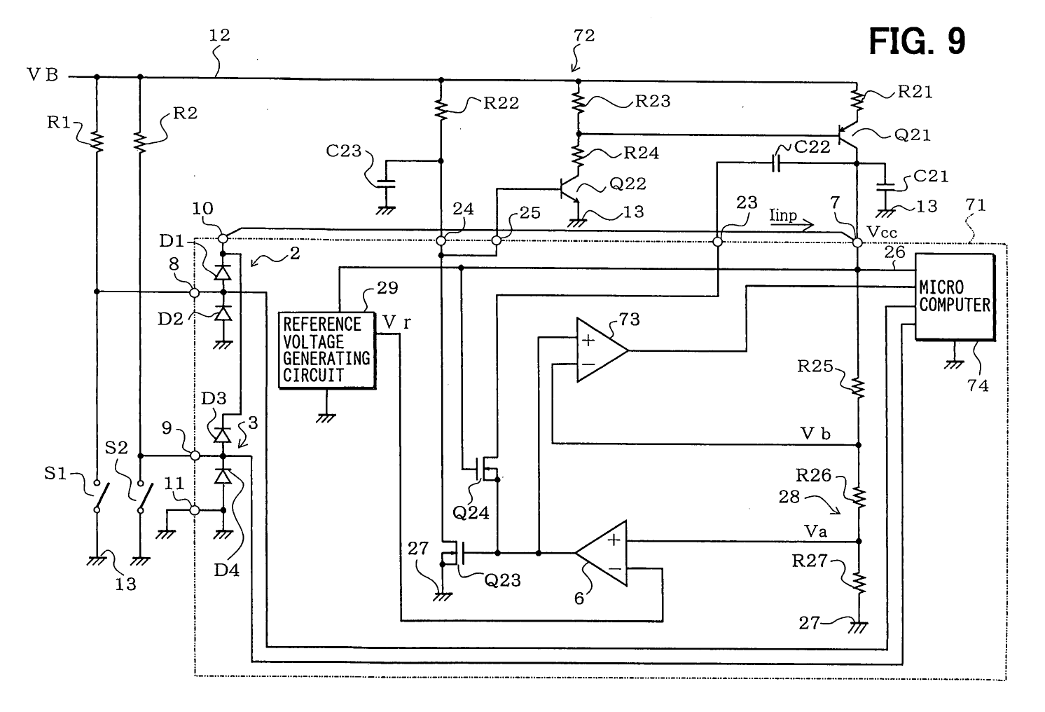

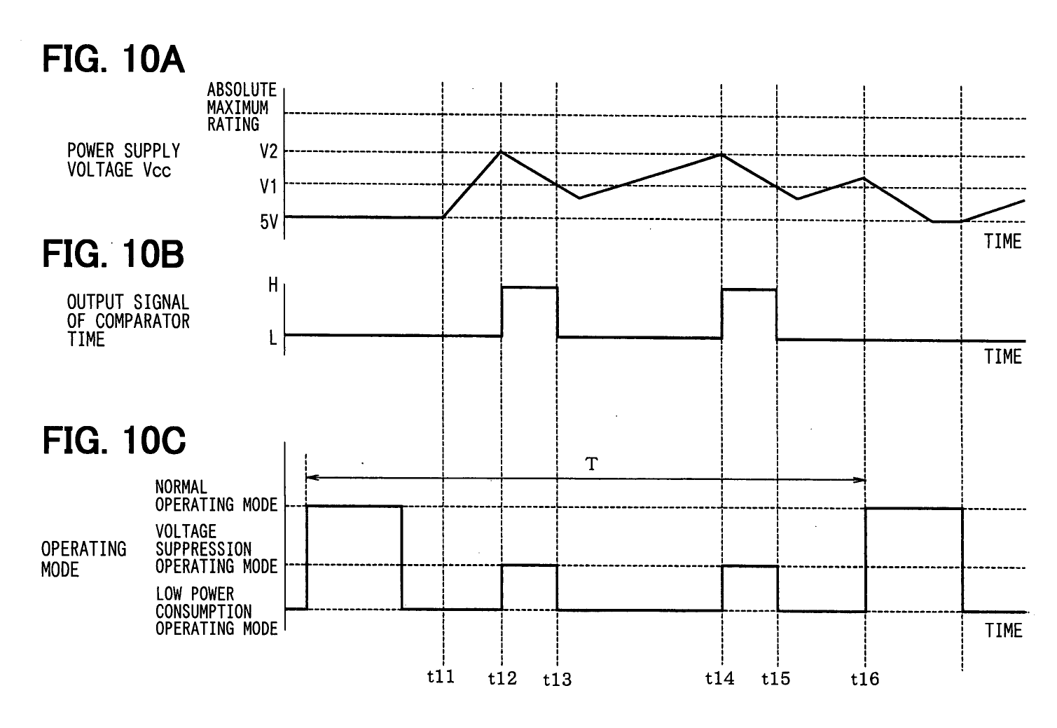

Next, a sixth embodiment of the present invention will be described with reference to FIGS. 9 and 10A-10C.

FIG. 9 shows the constructions of a power supply circuit and input protection circuit for an input port, and the same constituent elements as FIG. 1 are represented by the same reference numerals. This embodiment is different from the fifth embodiment in the processing content when the power supply voltage Vcc increases in the low power consumption operating mode.

IC 71 is supplied with a power supply voltage Vcc generated by a power supply circuit 72. In the power supply circuit 72, a comparator 73 (corresponding to the power supply voltage detecting circuit) has a hysteresis characteristic, and the non-inverted input terminal thereof is connected to the output terminal of the operational amplifier 6 while the inverted input terminal thereof is connected to a common connection point between the resistors R25 and R26. The output terminal of the comparator 73 is connected to an external interrupt terminal of a microcomputer 74.

FIG. 10A represents the power supply voltage Vcc, FIG. 10B represents an output signal of the comparator 73 and FIG. 10C represents the operating mode of the microcomputer 74. Even after an ignition key of a vehicle is turned off and the microcomputer 74 shifts to the low power consumption operating mode (sleep mode), the microcomputer 74 temporarily returns to the normal operating mode at a fixed period T to execute the monitoring processing of the input signal. When the switches S1 and S2 are set to OFF-state at a time t11 at which the microcomputer 74 is in the low power consumption operating mode, the flow-in current Iinp flowing into the terminal 7 exceeds the consumption current Icc of the IC internal circuits, so that the power supply voltage Vcc exceeds 5V and the control voltage output from the operational amplifier 6 increases.

Finally, when the power supply voltage Vcc reaches a judgment value (time t12), the control voltage of the operational amplifier 6 exceeds the detection voltage Vb of the voltage dividing circuit 28, the output signal of the comparator 73 varies its level from L-level to H-level, and the microcomputer 74 starts external interrupt processing. That is, the microcomputer 74 wakes up from the low power consumption operating mode, branches according to an interrupt vector and shifts to a voltage suppression operating mode for executing the processing of consuming current required to suppress increase of the power supply voltage Vcc. The voltage suppression operating mode may be the normal operating mode, however, in this embodiment, it is a special mode in which consumption current is smaller than that in the normal operating mode in order to suppress the power consumption to the required minimum value.

In the voltage suppression operating mode, the consumption current Icc of the IC internal circuits is larger than the flow-in current Iinp flowing into the terminal 7, so that the power supply voltage Vcc is reduced toward 5V. When the power supply voltage Vcc is reduced to less than a judgment value V1 (5V<V1<V2<absolute maximum rating of IC 71) (time t13), the output signal of the comparator 73 varies its level from H-level to L-level, and the microcomputer 74 shifts to the low power consumption operating mode again. As a result, the power supply voltage Vcc turns from decrease to increase again. As described above, the microcomputer 74 repeats the low power consumption operating mode and the voltage suppression operating mode until a time t16 at which it shifts to the next normal operating mode. In FIGS. 10A-10C, the inclination of the increase of the power supply voltage Vcc is different because the flow-in current Iinp varies due to variation of ON/OFF state of the switches S1, S2, variation of the battery voltage VB, etc.

According to this embodiment, when the power supply voltage Vcc exceeds the judgment value V2 during the period for which the microcomputer 74 is in the low power consumption operating mode, the microcomputer 74 immediately shifts to the voltage suppression operating mode having larger consumption current than that in the low power consumption operating mode without waiting for the next normal operating mode, so that the power supply voltage Vcc can be suppressed to substantially the judgment value V2. The consumption current Icc of IC 71 in the voltage suppression operating mode is set to be smaller than the consumption current Icc in the normal operating mode and also larger than the flow-in current Iinp flowing into the terminal 7, so that the increase of the consumption current Icc of IC 71 can be suppressed to the minimum level.

(Seventh Embodiment)

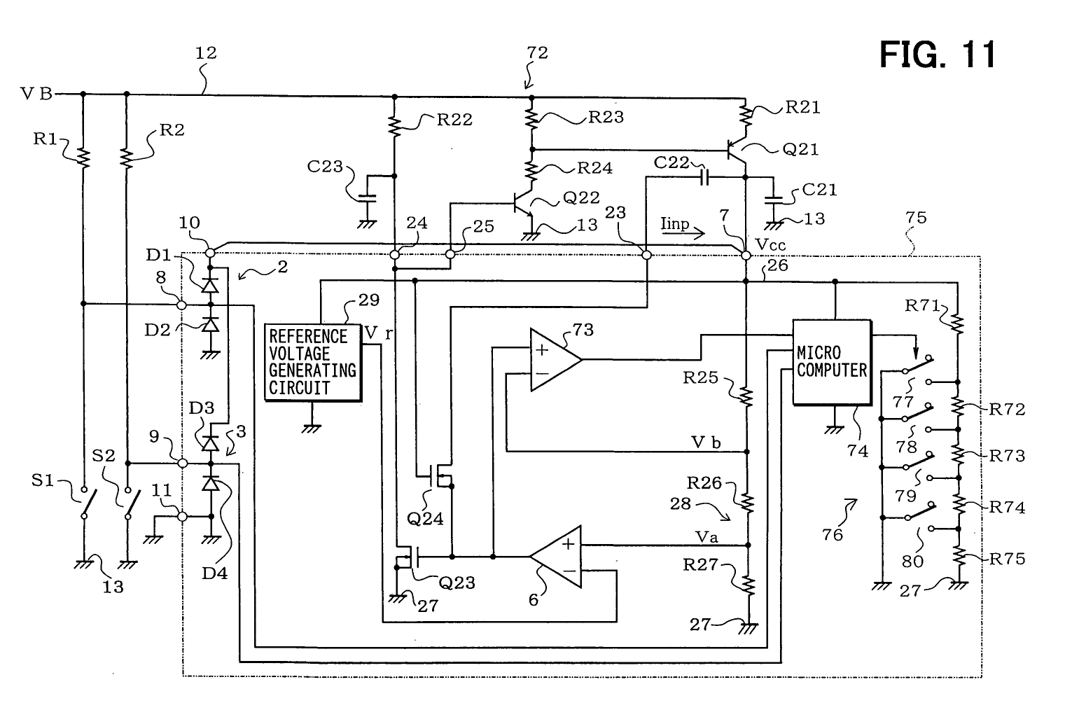

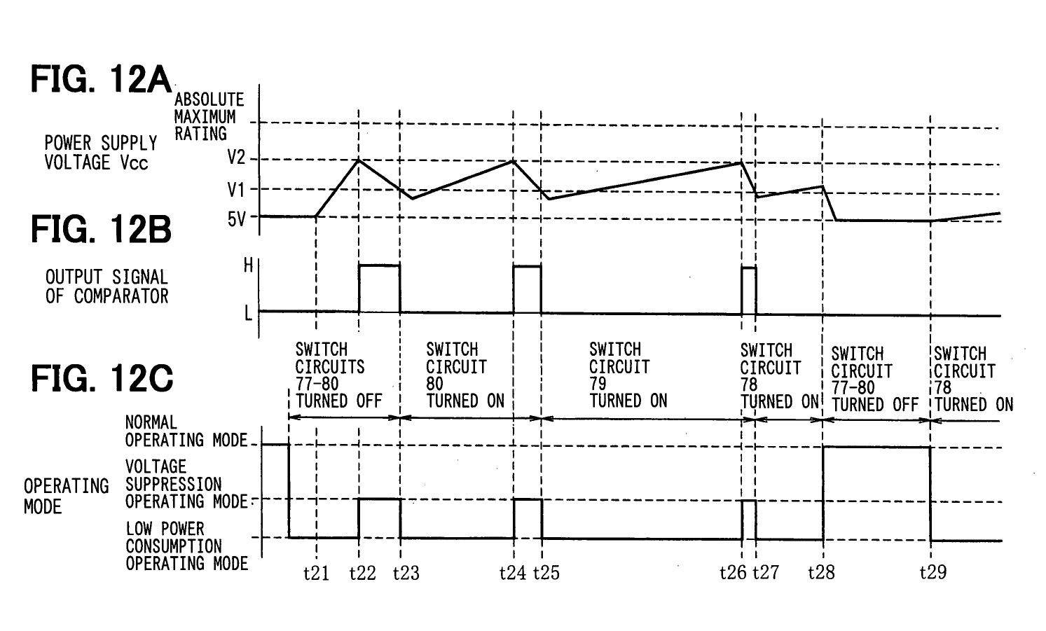

Next, a seventh embodiment achieved by modifying the sixth embodiment will be described with reference to FIGS. 11 and 12A-12C.

FIG. 11 shows the constructions of a power supply circuit and input protection circuits for an input port, and the same constituent elements as FIG. 9 are represented by the same reference numerals. A pseudo load circuit 76 whose resistance value is varied in accordance with a pseudo load setting signal from the microcomputer 74 is equipped in IC 75. The pseudo load circuit 76 comprises resistors R71 and R75 connected in series between the power supply line 26 and the ground line 27, and switch circuits 77 to 80 connected between a common connection point of these resistors R71 and R75 and the ground line 27. The switch circuits 77 to 80 are designed so that only any one of them is turned on in accordance with the pseudo load setting signal.

FIG. 12A shows the power supply voltage Vcc. FIG. 12B shows the output signal of the comparator 73. FIG. 12C shows the operating mode of the microcomputer 74 when the flow-in current Iinp flowing into the terminal 7 is fixed. The basic operation of this embodiment is the same as the sixth embodiment. That is, when the switches S1 and S2 are turned off at a time t21 at which microcomputer is in the low power consumption operating mode, the power supply voltage Vcc increases beyond 5V, and the microcomputer 4 starts the external interrupt processing at the time point when the power supply voltage Vcc reaches the judgment value V2 (time t22). However, it is assumed that the microcomputer 74 controls all the switch circuits 77 to 80 to OFF-state at the time point when the switches S1 and S2 are set to OFF-state.

The microcomputer 74 switches only the switch circuit 80 to ON-state in the external interrupt processing to set the resistance value of the pseudo load circuit 76 to be lower than the present resistance value by one step, thereby increasing the current flowing in the pseudo load circuit 76. The switching of the setting is actually carried out at the time point when the voltage suppression operating mode is finished and the microcomputer 74 returns to the low power consumption operating mode (time t23). Under this setting state of the pseudo load circuit 76, the increase of the power supply voltage Vcc is stopped when the consumption current Icc of IC 75 in the low power consumption operating mode increases to the flow-in current Iinp or more, and the microcomputer 74 keeps the low power consumption operating mode till a time t28 at which the microcomputer 74 shifts to the next normal operating mode.

On the other hand, when the consumption current Icc of IC 75 in the low power consumption operating mode is smaller than the flow-in current Iinp, the power supply voltage Vcc turns to increase again from the time t23 as shown in FIG. 12A, and finally the microcomputer 74 starts the external interrupt processing again (time t24). Therefore, the microcomputer 74 switches only the switch circuit 79 to ON-state in the external interrupt processing to further lower the resistance value of the pseudo load circuit 76 by only one step, thereby increasing the current flowing in the pseudo load circuit 76 (time t25). In the case shown in FIG. 12C, the microcomputer 74 starts the external interrupt processing once more at a time t26 to switch only the switch circuit 78 to ON-state (time t27).

When the microcomputer 74 shifts from the lower power consumption mode to the normal operating mode at a time t28, the microcomputer 74 sets all the switch circuits 77 to 80 to OFF-state. When the microcomputer 74 finishes the normal operating mode at a time t29 and shifts to the lower power consumption mode, it sets the pseudo load circuit 76 to the state just before the time t28 and continues the above control. Under only this control, the resistance value of the pseudo load circuit 76 can be merely reduced gradually. Therefore, when no shift to the voltage suppression operating mode occurs for a predetermined period, the resistance value of the pseudo load circuit 76 which was temporarily reduced is increased to be larger than the present resistance value by one step, thereby reducing the current flowing in the pseudo load circuit 76.

The switching control of the switch circuits 77 to 80 as described above is equivalent to the control of the resistance value of the pseudo load circuit 76 which is carried out so that the consumption current Icc (containing current flowing into the pseudo load circuit 76) of IC 75 in the low power consumption operating mode is larger than the flow-in current Iinp and also approaches to the flow-in current Iinp. That is, if this control is carried out, the consumption current of IC 75 in the low power consumption operating mode and the flow-in current Iinp are finally substantially equal to each other, and the microcomputer 74 is not shifted to the voltage suppression operating mode.

For example, even when the microcomputer 74 is in the voltage suppression operating mode, current which is remarkably larger than the flow-in current Iinp flows once the microcomputer 74 wakes up. Therefore, the average consumption current of IC 75 can be more frequently reduced by making the current substantially equal to the flow-in current Iinp flow into the pseudo load circuit 76 than by frequently shifting the microcomputer 74 to the voltage suppression operating mode. Accordingly, according to this embodiment, when there is some flow-in current Iinp into the terminal 7, the increase of the power supply voltage Vcc can be suppressed with further reducing the consumption current.

(Other Embodiments)

The present invention is not limited to the respective embodiments described above and shown in the drawings, and the following modifications and expansions can be carried out, for example.

In the first to third embodiments, the transistor Q26 and the start-up circuit 32 may be equipped as occasion demands. Furthermore, the input protection circuits 2 and 3 may be equipped to the outside of IC.

In the second embodiment, in a case where the operations of the operational amplifiers 6 and 31 are satisfied even when the reference voltage Vr is directly applied to the inverted input terminal of the operational amplifier 31, the amplifying circuit 36 may be omitted.

In the third embodiment, when it is possible to manufacture the circuit so that the threshold voltage Vt (Q29) of the transistor Q29 is higher than the threshold voltage Vt (Q23) of the transistor Q23 by only a predetermined offset voltage, the resistor R35 may be omitted. The offset voltage concerned may be secured by other means.

In the fourth embodiment, an operational amplifier and a voltage adding circuit which are designed in a voltage follower connection style may be used in place of the A/D converter 42 and the D/A converter 43. The gate-source voltage of the transistor Q25 is detected (A/D-converted) at the start time of the return control period Tβ. However, when the flow-in current Iinp is fixed or the variation thereof is slight, the gate-source voltage of the transistor Q25 may be detected (A/D-converted) before the return control period Tβ in the low power consumption operating mode.

In the fifth embodiment, when the judgment signal is set to H-level during the operation in the low power consumption operating mode, the microcomputer may immediately shift to the normal operating mode without waiting for shifting to the next normal operating mode.

In each of the embodiments, the power supply circuits 22, 34, 38, 54 and 72 are not limited to the series regulator type, and it may be generally various types such as a linear regulator, a switching regulator, etc.

The description of the invention is merely exemplary in nature and, thus, variations that do not depart from the gist of the invention are intended to be within the scope of the invention. Such variations are not to be regarded as a departure from the spirit and scope of the invention.

1. A power supply circuit comprising:
a voltage generating circuit for generating an output voltage equal to a target voltage on the basis of an input voltage applied to an input line, and supplying the output voltage thus generated through an output line to a load; and
a current sink circuit into which excess current flows, the excess current being defined as overflow current out of current flowing from the external to the output line over the total current of current supplied to the load, operating current of the voltage generating circuit and operating current of the current sink circuit itself.

2. The power supply circuit according to claim 1, wherein the current sink circuit carries out a sink operation of inpouring the excess current therein in when the output voltage exceeds the target voltage.

3. The power supply circuit according to claim 1, wherein:
the voltage generating circuit comprises a first error amplifier for amplifying a differential voltage between the target voltage and the output voltage; and
the current sink circuit comprises:
a first transistor connected to the output line to form a current inpouring passage;
a voltage detecting circuit for dividing the output voltage so that a voltage higher than a control voltage output from the first error amplifier is detected when the voltage generating circuit outputs a voltage equal to the target voltage; and
a second error amplifier for controlling the first transistor in accordance with the differential voltage between the control voltage output from the first error amplifier and the detection voltage.

4. The power supply circuit according to claim 1, wherein:
the voltage generating circuit comprises a first error amplifier for amplifying a differential voltage between the target voltage and the output voltage; and
the current sink current comprises:
a first transistor which is connected to the output line to form a current inpouring passage;
a reference voltage outputting circuit for outputting a fixed reference voltage higher than a control voltage output from the first error amplifier when the voltage generating circuit outputs a voltage equal to the target voltage; and
a second error amplifier for controlling the first transistor in accordance with a differential voltage between the control voltage output from the first error amplifier and the reference voltage.

5. The power supply circuit according to claim 1, wherein the voltage generating circuit comprises:
a first error amplifier for amplifying a differential voltage between the target voltage and the output voltage; and
a second transistor operating with a control voltage output from the first error amplifier as a gate voltage,
wherein the current sink circuit comprises:
a first transistor which is connected to the output line to form a current inpouring passage;
a third transistor which has a threshold voltage higher than the second transistor by a predetermined offset voltage, and operates with a control voltage output from the first error amplifier as a gate voltage; and a second error amplifier for controlling the first transistor in accordance with the differential voltage between the drain voltage of the third transistor and a predetermined reference voltage.

6. The power supply circuit according to claim 1, further comprising a start-up circuit for keeping the first transistor to OFF-state from a time when a voltage is applied to the input line until a time when the output voltage reaches a predetermined voltage.

7. A power supply circuit comprising:
a voltage generating circuit for generating an output voltage equal to a target voltage, and supplying the voltage thus generated through an output line to a load; and
a current sink circuit into which current flowing from the external to the output line is inpoured so that the output voltage does not exceed a predetermined voltage set to be higher than the target voltage when it is impossible for the voltage generating circuit to carry out tracking control to the target voltage while the output voltage is kept to be higher than the target voltage.

8. A semiconductor integrated circuit device comprising:
the power supply circuit according to claim 1;
a microcomputer which is supplied with a voltage from the power supply circuit to operate, and can operate in any one of a normal operating mode and a low power consumption operating mode having power consumption smaller than the normal operating mode;
a signal input terminal to which a signal voltage is input; and
an input protection circuit connected between the signal input terminal and the output line of the power supply circuit.

9. The semiconductor integrated circuit device according to claim 8, further comprising:
a pseudo load circuit which is connected to the output line of the power supply circuit and varies the magnitude of current flowing therein in accordance with a pseudo load setting signal; and
a pseudo load control circuit for supplying the pseudo load setting signal to the pseudo load circuit so that in a return control period having a predetermined width just before the microcomputer shifts from the low power consumption operating mode to the normal operating mode, current which is equal to or larger than current flowing in the current sink circuit before the return control period and also smaller than consumption current of the microcomputer in the normal operating mode flows in the pseudo load circuit.

10. The semiconductor integrated circuit device according to claim 9, wherein each of the current sink current and the pseudo load circuit has a series circuit comprising a resistor and a transistor, the series circuits of both the current sink current and the pseudo load circuit forming a current inpouring passage and having the same characteristic, and the pseudo load control circuit detects the gate voltage of the transistor constituting the series circuit of the current sink circuit before the return control period, and applying a gate voltage not less than the gate voltage thus detected to the transistor constituting the series circuit of the pseudo load circuit in the return control period.

11. A semiconductor integrated circuit device having a microcomputer which is supplied with a predetermined power supply voltage from an internal power supply circuit or an external power supply circuit, selects one of any one of a normal operating mode and a low power consumption operating mode and operates in the mode thus selected, the microcomputer comprising:
a power supply voltage detecting circuit for detecting that the power supply voltage increases to a value higher than a judgment reference value, wherein when selecting the low power consumption operating mode, the microcomputer intermittently shifts to the normal operating mode and operates in the normal operating mode, and continues to operate in the normal operating mode after shifting to the normal operating mode concerned while the power supply voltage detecting circuit detects the increase of the power supply voltage.

12. The semiconductor integrated circuit device according to claim 11, wherein the power supply voltage detecting circuit comprises:
a judgment reference voltage generating circuit for generating the judgment reference voltage; and
a comparator for comparing the power supply voltage with the judgment reference voltage.

13. The semiconductor integrated circuit device according to claim 11, wherein the microcomputer carries out the intermittent operation at a period of ΔVm/Rm or less, wherein Rm [V/s] represents the maximum voltage increase rate estimated for the power supply voltage, and ΔVm represents the voltage difference between the judgment voltage and the maximum permissible voltage for the power supply voltage.

14. The semiconductor integrated circuit device according to claim 12, wherein the microcomputer shifts to a voltage suppression operating mode having larger consumption current than that in the low power consumption operating mode when the power supply voltage detecting circuit detects the increase of the power supply voltage while the microcomputer selects the low power consumption operating mode.

15. The semiconductor integrated circuit device according to claim 14, wherein the comparator has a hysteresis characteristic, and the microcomputer selects the low power consumption operating mode or the voltage suppression operating mode according to a signal output from the comparator during a period for which it is scheduled to select the low power consumption operating mode under the intermittent operation.

16. The semiconductor integrated circuit device according to claim 15, further comprising a pseudo load circuit for varying the magnitude of current flowing therein in accordance with a pseudo load setting signal, wherein the microcomputer controls the pseudo load setting signal so as to increase current flowing in the pseudo load circuit every time the microcomputer selects the voltage suppression operating mode.

17. The semiconductor integrated circuit device according to claim 11, further comprising a signal input terminal to which an input protection circuit for clamping an input signal voltage to the power supply voltage is connected.

18. The semiconductor integrated circuit device according to claim 12, wherein the microcomputer carries out the intermittent operation at a period of ΔVm/Rm or less, wherein Rm [V/s] represents the maximum voltage increase rate estimated for the power supply voltage, and ΔVm represents the voltage difference between the judgment voltage and the maximum permissible voltage for the power supply voltage.

19. A semiconductor integrated circuit device comprising:
the power supply circuit according to claim 3;
a microcomputer which is supplied with a voltage from the power supply circuit to operate, and can operate in any one of a normal operating mode and a low power consumption operating mode having power consumption smaller than the normal operating mode;
a signal input terminal to which a signal voltage is input; and
an input protection circuit connected between the signal input terminal and the output line of the power supply circuit.

20. A semiconductor integrated circuit device comprising:
the power supply circuit according to claim 4;
a microcomputer which is supplied with a voltage from the power supply circuit to operate, and can operate in any one of a normal operating mode and a low power consumption operating mode having power consumption smaller than the normal operating mode;
a signal input terminal to which a signal voltage is input; and
an input protection circuit connected between the signal input terminal and the output line of the power supply circuit.
